(19) United States
(12) Patent Application Publication
(10) Pub. No.: US 2024/0367467 A1
(43) Pub. Date: Nov. 7, 2024

(54) TIRE INVERTING DEVICE AND METHOD

(71) Applicant: Wesley Sanford, Waddy, KY (US)

(72) Inventor: Wesley Sanford, Waddy, KY (US)

(21) Appl. No.: 18/142,303

(22) Filed: May 2, 2023

(51) Int. Cl. B60C 25/15

(52) U.S. Cl. CPC B60C 25/15

(57) ABSTRACT

Presently provided is a tire inverting device and method. The device has a base with a central support, a pushing mechanism, and a tire holding device. The tire holding device holds a first circumferential edge of a tire while the pushing mechanism axially pushes a second circumferential edge of the tire from the central support and through the first circumferential edge by a sufficient amount to invert the tire. The device has a central axis about which the tire, the central support, the pushing mechanism, and the tire holding device are all centrally disposed or moved about.

### FIELD OF INVENTION

The present invention relates to tire inverting devices and methods.

### BACKGROUND OF THE INVENTION

The disposal of old tires can pose several problems, including environmental, health, and safety concerns. Some of the key problems associated with disposing of old tires include environmental pollution, fire hazards, health risks, aesthetics and blight, cost burden, and lack or recycling and sustainable disposal options. For example, when old tires are not disposed of properly, they can contribute to environmental pollution. Tires are not biodegradable and do not break down naturally, which means they can persist in the environment for a long time. When tires are discarded in landfills or dumped in inappropriate locations, polluting the environment, and posing a risk to local ecosystems and wildlife. Old tires are flammable and can easily catch fire, leading to serious fire hazards. Improper disposal of old tires can also result in health risks for humans. Old tires can provide a breeding ground for disease-carrying mosquitoes, as they can collect stagnant water and create ideal breeding sites. Discarded tires that are not properly managed can create an eyesore and contribute to blight in communities. Piles of old tires can accumulate in illegal dumping sites, vacant lots, or abandoned properties, negatively impacting the aesthetics of the area and reducing property values. Disposing of old tires can be expensive, and improper disposal practices can result in additional costs for local governments and taxpayers. Cleaning up illegal tire dumping sites, managing fire hazards, and addressing environmental and health impacts can require significant resources and financial burdens for local communities.

A lack of recycling and sustainable disposal options is a major contribution to the above mentioned problems associated with old tires. While some tires can be recycled or repurposed for various uses, such as crumb rubber for sports surfaces or fuel for cement kilns, the recycling infrastructure for tires is not always widely available or economically viable in all areas. This can result in a lack of sustainable disposal options for old tires, leading to increased risks of improper disposal and associated problems.

Some tires may be repurposed by making usable products such as containers, planters, or ornamental products. Turning a tire inside out, or inverting, may provide for the repurposing or upcycling of tires. Traditional methods of turning a tire inside out, or inverting, can be a challenging and dangerous task that requires careful preparation and proper tools. These traditional methods may involve deflating the tire by removing the valve cap and using a valve core tool to deflate the tire completely. The deflated tire is then removed from the rim with a tire changing machine, tire irons, or pry bars by first breaking the bead of the tire and then carefully lifting the tire off the rim. The inside of the tire is then lubricated with tire mounting paste or soapy water. The tire may then be inverted by first pushing or pulling a tire bead to the opposite side of the tire with the tire changing machine, tire irons, or pry bars. Finally, the tire may be inverted by working around the tire gradually with a twisting motion until the entire tire is turned inside out. Care needs be taken as excessive force may damage the tire or cause injury to the person inverting the tire.

It may be desirous to provide a tire inverting device and method that overcome some of the problems associated with the current devices and practices.

### SUMMARY

In one aspect of the present disclosure, a tire inverting device is provided. The tire inverting device has a base with a central support. A pushing mechanism has a first end extending from the central support of the base, a second end, and an extendable length extending between the first end and the second end, the pushing mechanism and the central support forming a central axis. A tire holding device is configured and disposed to hold a first circumferential edge of a tire being inverted a first distance from the base and axially centered with the central axis. The pushing mechanism has its second end configured to cooperate with a second circumferential edge of the tire being inverted, upon an extending of the extendable length of the pushing mechanism. The pushing mechanism is configured and disposed to move its second end and the cooperated second circumferential edge of the tire being inverted along the central axis and to a second distance from the base. The second distance from the base is greater than the first distance from the base by a sufficient amount to invert the tire being inverted.

In another aspect of the present disclosure, a method of inverting a tire is provided. The method comprises the steps of: placing a second circumferential edge or second sidewall of the tire being inverted on a base or stand; holding a first circumferential edge of the tire a first distance from the base; extending a first end of a pushing mechanism from a central support of the base; axially aligning an extendable length of the pushing mechanism with the central support and a central axis of the tire, forming a central axis; axially extending the extendable length of the pushing mechanism along the central axis and cooperating a second end of the pushing mechanism with the second circumferential edge of the tire; pushing the second circumferential edge of the tire, with the mechanism, to a second distance from the base; and wherein the second distance from the base is greater than the first distance from the base by an amount sufficient to invert the tire being inverted, thus inverting the tire.

### BRIEF DESCRIPTION OF THE DRAWINGS

The foregoing and other features of this disclosure will become more fully apparent from the following description and appended claims, taken in conjunction with the accompanying drawings and examples. Understanding that these drawings depict only several embodiments in accordance with the disclosure and are therefore, not to be considered limiting of its scope, the disclosure will be described with additional specificity and detail through use of the accompanying drawings.

The following figures, which are idealized, are not to scale and are intended to be merely illustrative of aspects of the present disclosure and non-limiting. In the drawings, like elements may be depicted by like reference numerals. The drawings are briefly described as follows:

FIG. 1 shows an illustrative example of the presently disclosed tire inverting device;

FIG. 2 shows the illustrative example of the tire inverting device shown in FIG. 1 having a tire disposed for inverting;

FIG. 3 shows the illustrative example of the tire inverting device shown in FIG. 1 having a tire being inverted;

FIG. 4 shows the illustrative example of the tire inverting device shown in FIG. 1 having a holding device removed upon the tire being inverted;

FIG. 5 shows an illustrative example of a tire that has been inverted with the inverting device shown in FIG. 1;

FIG. 6 shows an illustrative example of a tire that may be inverted with the presently disclosed tire inverting device; and

FIG. 7 schematically shows a top and a cross-sectional view of an illustrative example of the presently disclosed tire inverting device.

### DETAILED DESCRIPTION OF THE INVENTION

The present disclosure provides a tire inverting device and a method for inverting a tire. The presently disclosed tire inverting device has a base or stand where a lower sidewall or bead of the tire is placed. A top sidewall, bead, or remaining upper portion of the tire is held in place at its edge. A pushing mechanism is longitudinally disposed with a center axis of the tire and has a top end that cooperates with the lower edge or bead of the tire when the pushing mechanism is longitudinally extended. The pushing mechanism is configured and disposed to push the lower sidewall or bead of the tire up through the held edge of the tire which inverts the tire.

In at least one embodiment, the tire inverting device has a base with a central support, a pushing mechanism, and a tire holding device. The tire holding device holds a first circumferential edge of a tire while the pushing mechanism axially pushes a second circumferential edge of the tire from the central support and through the first circumferential edge by a sufficient amount to invert the tire. The device has a central axis about which the tire, the central support, the pushing mechanism, and the tire holding device are all centrally disposed or moved about. For example, the pushing mechanism may push along the central axis and the tire may be inverted about the central axis. This configuration may provide for smaller, more compact, or lighter device which may be more easily transported than other tire inverting devices.

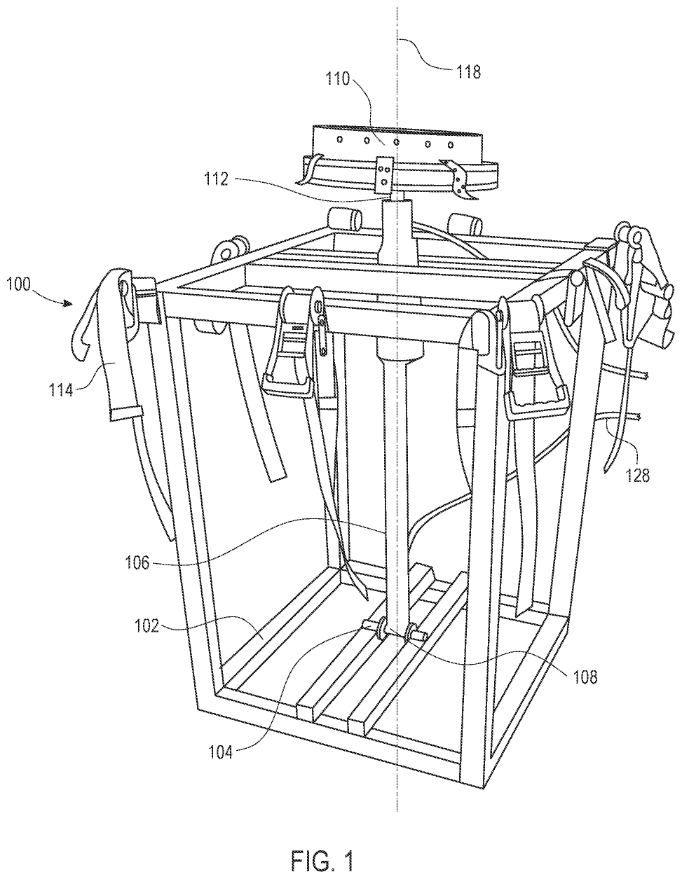

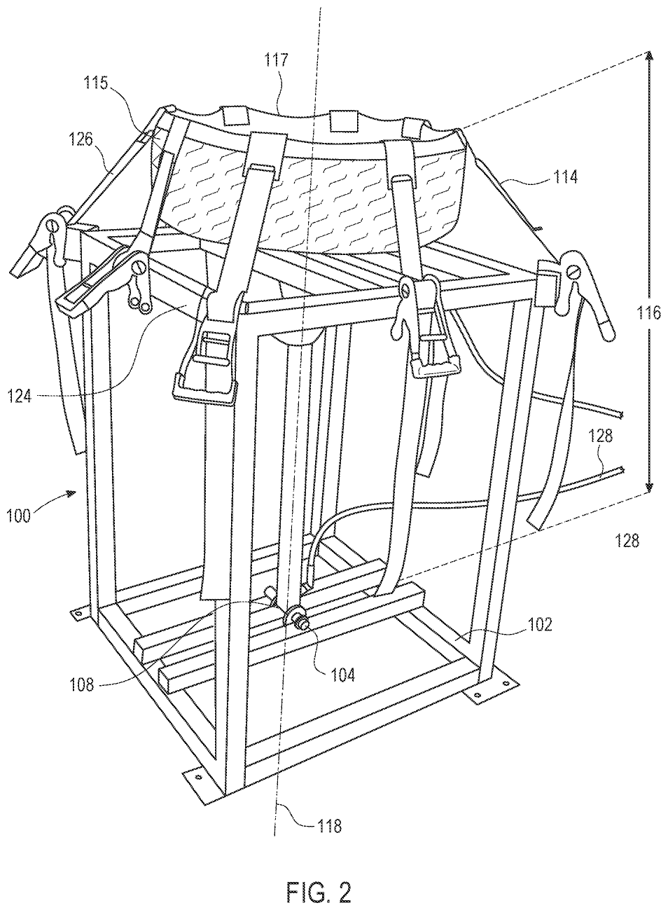

FIG. 1 shows an illustrative example of the presently disclosed tire inverting device, tire inverting device 100. FIG. 2 shows tire inverting device 100 having tire 115 disposed for inverting. Tire inverting device 100 has a base 102 with a central support 104. A pushing mechanism 106 has a first end 108 extending from central support 104 of the base 102, a second end 110, and an extendable length 112 axially extending between first end 108 and second end 110. Base 102 and the axis of pushing mechanism 106 form a central axis. A tire holding device 114 is configured and disposed to hold a first circumferential edge 117 of a tire being inverted a first distance 116 from base 102 and axially centered with central axis 118, as shown in FIG. 2.

Pushing mechanism 106 has its second end 110 configured to cooperate with a second circumferential edge 119 of tire 115, upon an extending of the extendable length 112 of pushing mechanism 106. For example, a wheel, rim, portion of a rim, or other outward extension(s) may be disposed on second end 110. Pushing mechanism 106 is configured and disposed to move its second end 110 and cooperated second circumferential edge 119 of tire 115 along central axis 118 and to a second distance 120 from base 102. Second distance 120 from base 102 is greater than first distance 116 from base 102 by an amount sufficient to invert tire 115.

In at least one embodiment of the present disclosure, pushing mechanism 106 has a wheel rim, or portion thereof, disposed on second end 110 for cooperating with second circumferential edge 119. For example, pushing mechanism 106 may have a wheel rim disposed with its second end 110 as shown in FIG. 1.

In at least one embodiment, tire holding device 114 has a stand 124 held to, and at a distance from, base 102. Stand 124 is configured and disposed to hold tire 115, dispose tire holding device 114, and hold pushing mechanism 106, with its longitudinal axis 118 axially centered with central support 104. Stand 124 is configured and disposed to hold pushing mechanism 106 with its longitudinal axis axially aligned with the central axis 118. As shown in FIG. 2, first circumferential edge 117 of tire 115 may have its bead removed and tire holding device 114 may be configured and disposed to cooperate with the sidewall or tread portion of tire 115. For example, the tire bead about first circumferential edge 117 may need be cut, compromised, separated, or removed to reduce a resistance to the passing of second circumferential edge 119 through tire 115 along central axis 118.

In at least one embodiment, tire holding device 114 is adjustable and configured and disposed to hold first circumferential edge 117 of different sized tires at first distance 116 from base 102. For example, holding device 114 may comprise a plurality of adjustable straps.

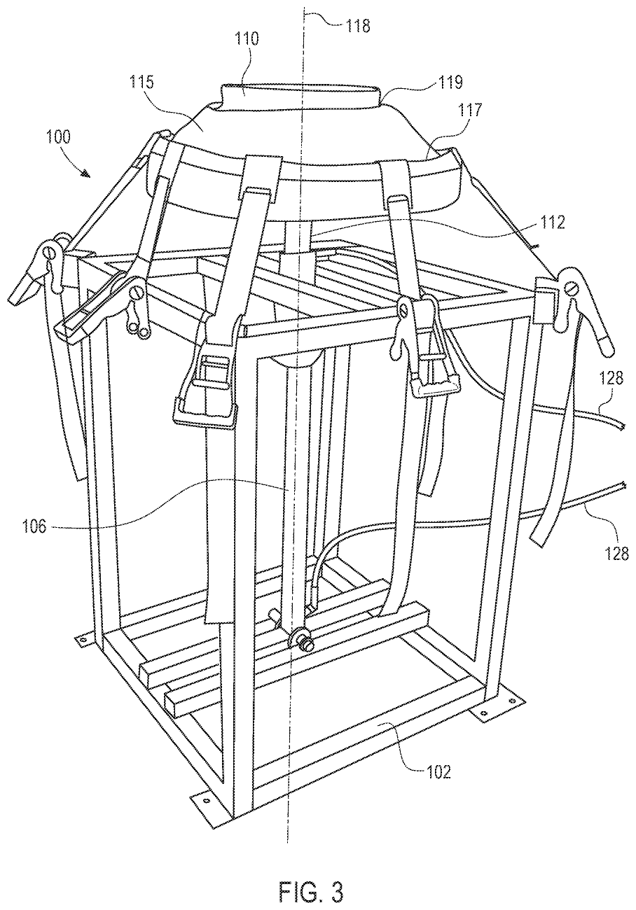

FIG. 3 shows the illustrative example of the tire inverting device 100 having tire 115 being inverted. Second circumferential edge 119 of tire 115 a tire bead and second end 110 of pushing mechanism 106 is configured to cooperate with the tire bead. For example, second end 110 may have a wheel rim, or portion thereof, configured and disposed to cooperate with the tire bead. Pushing mechanism 106 may be hydraulically, electrically, or pneumatically activated. In at least one embodiment, an external power source is configured and disposed to activate pushing mechanism 106. For example, a hydraulic line 128 may supply power to pushing mechanism 106 for activation and the extending of extendable length 112 disposed between first end 108 and second end 110 of pushing mechanism 106.

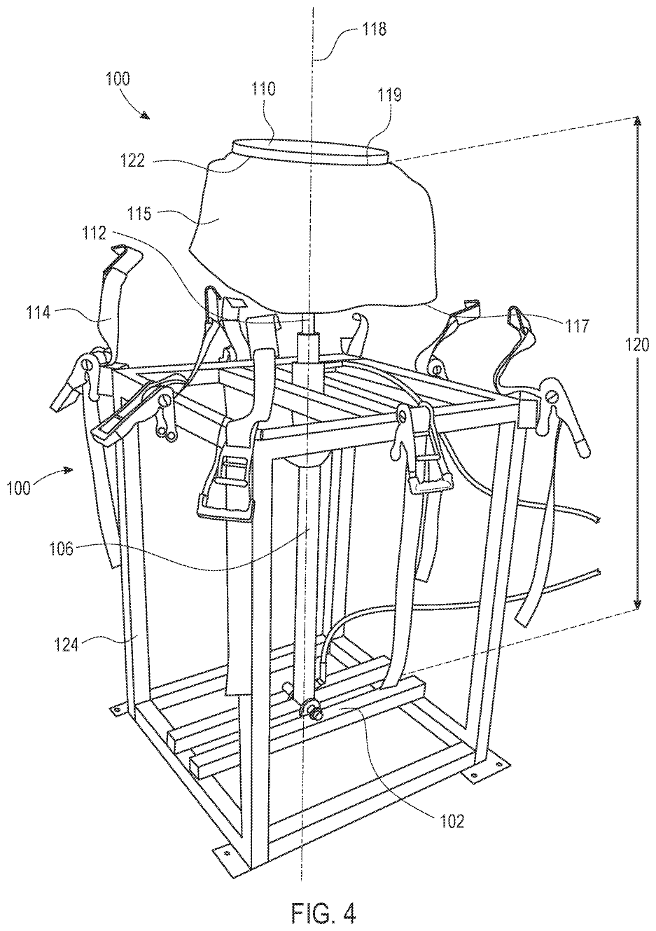

FIG. 4 shows the illustrative example of the tire inverting device 100 having holding device 114 removed upon tire 115 being inverted. Upon pushing mechanism 106 moving its second end 110, and cooperated second circumferential edge 119 of tire 115, to second distance 120 from base 102, tire 115 is inverted. Second distance 120 from base 102 is greater than first distance 116 from base 120 by a sufficient amount to invert tire 115. The movement of second circumferential edge 119 up and through first circumferential edge 117, along central axis 118, needed to invert a tire may vary for different sizes and configurations of tires.

In at least one embodiment, tire holding device 114 is configured and disposed to automatically release from tire 115, upon tire 115 being inverted. For example, tire holding device 114 may have a plurality of straps with hook shaped ends that are configured to automatically remove from tire 115 being inverted as shown in FIG. 4. Holding device 114 may be adjustable in length for holding first circumferential edge 117 of different sizes and configurations of tires 115. For example, holding device 114 may have a plurality of adjustable straps.

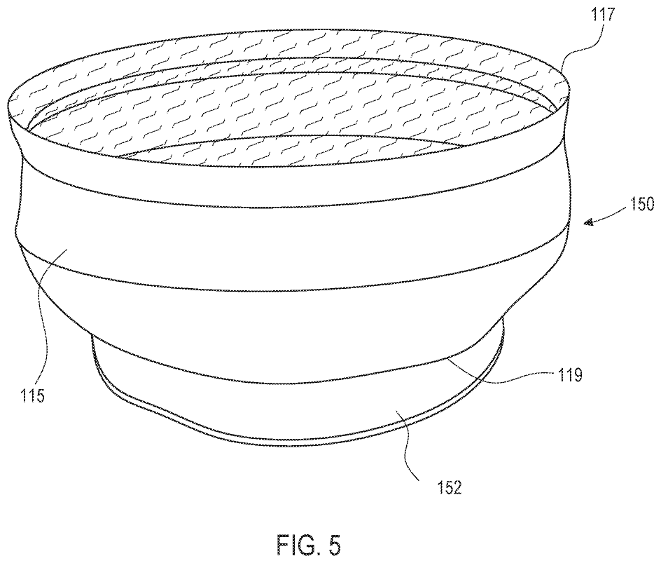

FIG. 5 shows an illustrative example of a tire that has been inverted with the inverting device 100. Upon inverting tire 115, it may be repurposed or upcycled for a variety of uses 150. For example, a portion of the bead or sidewall of tire 115 may have been removed, disposing first circumferential edge 117, prior to inverting. The removed portion 152 may be attached to tire 115 about second circumferential edge 119. Tire 115 may be repurposed or upcycled into a planter, container, or other containing or holding device. For example, a bottom wall may be placed on second circumferential edge 119, inside of inverted tire 115, for holding items or soil for planting.

Inverted tire 115 may be inspect and cleaned with water and a mild detergent to remove any lubricant residue or dirt. The inverted tire may be used for creating tire art which may be a unique and creative way to repurpose or upcycle old or used tires, and transform them into functional and aesthetically appealing pieces of art. For example, designs may be cut out of the upwardly extending sidewall and/or the tire may be painted. Placement of colors, patterns, and any other decorative elements may be selected to form unique designs. The finished tire art may be displayed indoors or outdoors or even be repurposed into functional furniture such as a coffee table or ottoman.

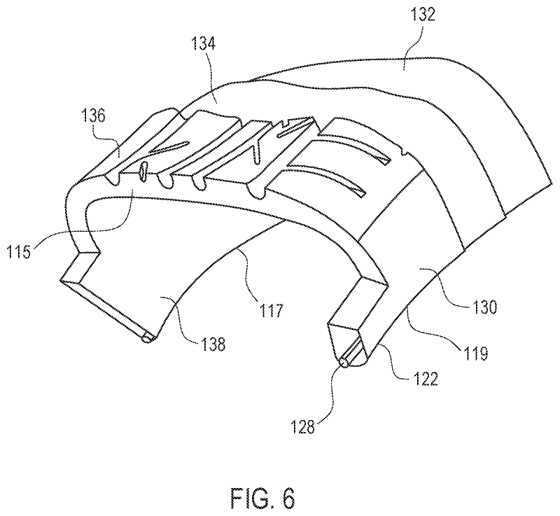

FIG. 6 shows an illustrative example of tire 115 that may be inverted with the presently tire inverting device 100 or 200. Typically, tires have two opposing sidewalls 130. Each sidewall may have a tire bead 122 with a bead filler 128 configured and disposed to mount and seal on a rim. Tires typically have layers such as an inner liner 138, radial cord body 132, and belt piles 134. Thread 136 is typically disposed on belt piles 134.

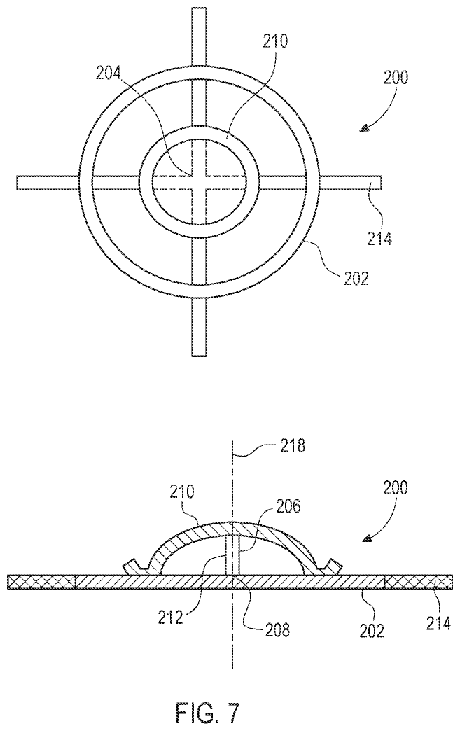

FIG. 7 schematically shows a top and a cross-sectional view of an illustrative example of the presently disclosed tire inverting device 200. Tire inverting device 200 has a base 202 with a central support 204. Pushing mechanism 206 has a first end 208 extending from central support 204, a second end 210, and an extendable length 212 extending between first end 208 and second end 210. Pushing mechanism 206 and central support 204 form a central axis 218. Tire holding device 214 is configured and disposed to hold a first circumferential edge of a tire being inverted a first distance from the base and axially centered with central axis 218. Pushing mechanism 206 has its second end 210 configured to cooperate with a second circumferential edge of the tire being inverted, upon extending of extendable length 212. Pushing mechanism 206 is configured and disposed to move its second end 210 and the cooperated second circumferential edge of the tire being inverted along central axis 218 and to a second distance from base 204. The second distance from base 204 is greater than the first distance from the base 204 by a sufficient amount to invert the tire being inverted.

A method of inverting a tire is presently disclosed. The method comprises placing a second circumferential edge or second sidewall of a tire being inverted on a base or stand and holding a first circumferential edge of the tire a first distance from the base. A first end of a pushing mechanism is extended from a central support of the base and an extendable length of the pushing mechanism is axially aligned with the central support and a central axis of the tire, forming a central axis. The extendable length of the pushing mechanism is axially extended along the central axis and cooperates a second end of the pushing mechanism with the second circumferential edge of the tire. The second circumferential edge of the tire is pushed, with the pushing mechanism, to a second distance from the base. The second distance from the base is greater than the first distance from the base by an amount sufficient to invert the tire, thus inverting the tire.

In at least one embodiment, at least a portion of a bead disposed proximate the first circumferential edge of the tire is compromising, separated, or remove, prior to the placing of the second circumferential edge or second sidewall of the tire on the base or stand. The cooperating the second end of the pushing mechanism may comprise cooperating the second end with a tire bead disposed proximate the second edge of the tire. In at least one embodiment, the cooperating the second end of the pushing mechanism comprises cooperating a wheel rim, or portion thereof, disposed with the second end of the pushing mechanism with the tire bead.

In at least one embodiment, a tire holding device is adjusted to hold the first circumferential edge of the tire at the first distance from the base. The adjusting of the tire holding device to hold the first circumferential edge of the tire at the first distance from the base may comprises tightening a plurality of adjustable straps.

The placing of the second circumferential edge or second sidewall of the tire on the base or stand may comprise placing the second circumferential edge or second sidewall of the tire on the stand, the stand is held to, and at a distance from, the base. The holding of the first circumferential edge of the tire the first distance from the base may comprise holding the first circumferential edge of the tire to the stand with a holding device.

The method of inverting a tire may comprise hydraulically, electrically, or pneumatically activating the pushing mechanism and extending its extendable length. The holding device may be automatically released from the first circumferential edge of the tire upon the inverting of the tire.

At least a portion of the sidewall with the bead disposed proximate the first circumferential edge of the tire may be removed prior to placing the tire on the base or stand. The removed sidewall portion may be attached to the second circumferential edge or second sidewall of the tire, upon the inverting of the tire.

### Nomenclature

tire inverting device 100
base 102
central support; 104
pushing mechanism 106
first end of pushing mechanism 108
second end of pushing mechanism 110
extendable length 112
tire holding device 114
tire 115
first distance 116
first edge of tire 117
central axis 118
second edge of tire 119
second distance from the base 120
tire bead 122
stand 124
tire holder 126
bead filler 128
sidewall 130
radial cord body 132
belt piles 134
tread 136
inner liner 138
repurposed tire 150
removed sidewall portion 152
tire inverting device 200
base 202
central support 204
pushing mechanism 206
first end 208
second end 210
extendable length 212
tire holding device 214
central axis 218

It will be understood that the examples of patents, published patent applications, and other documents which are included below in this application and which are referred to in paragraphs which state “Some examples of . . . which may possibly be used in at least one possible embodiment of the present application . . . ” may possibly not be used or useable in any one or more embodiments of the application. These references, or portions thereof, are hereby incorporated by reference herein. The purpose of incorporating U.S. patents, foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

Some examples of features which may possibly be utilizable by at least one possible embodiment may possibly be found in the following which are incorporated by reference herein:

U.S. Pat. No. 4,278,413 titled “APPARATUS FOR INVERTING TIRES”, by Hilt, Merlyn R., filed Sep. 20, 1979 and RE31958 titled “APPARATUS FOR TURNING TIRES INSIDE OUT”, by Hilt, Merlyn R., filed May 31, 1983.

1. A tire inverting device comprising:
a base with a central support;
a stand disposed a distance from the base, the stand being configured to cooperate with a tire holding device and to support a second circumferential edge or a second sidewall of a tire being inverted;
a pushing mechanism having a first end extending from the central support of the base, a second end, and an extendable length extending between the first end and the second end, the pushing mechanism and the central support forming a central axis;
the stand is configured and disposed to hold the pushing mechanism with its longitudinal axis axially centered with the central support and the central axis;
the tire holding device is adjustable and configured to adjustably hold a first circumferential edge of the tire to the stand and is configured and disposed to hold the first circumferential edge of the tire being inverted a first distance from the base and axially centered with the central axis;
the pushing mechanism has its second end configured to cooperate with the second circumferential edge of the tire being inverted, upon an extending of the extendable length of the pushing mechanism;
the pushing mechanism is configured and disposed to move its second end and the cooperated second circumferential edge of the tire being inverted along the central axis and to a second distance from the base; and
wherein the second distance from the base is greater than the first distance from the base by an amount sufficient to invert the tire being inverted.

2. The tire inverting device of claim 1, wherein the first circumferential edge of tire has its bead separated, compromised, or removed and the tire holding device is configured and disposed to cooperate with the sidewall or tread portion of the tire.

3. The tire inverting device of claim 1, wherein the second circumferential edge of the tire being inverted has a tire bead and the second end of the pushing mechanism is configured to cooperate with the tire bead.

4. The tire inverting device of claim 3, wherein the pushing mechanism has at least a portion of a wheel rim disposed with its second end.

5. The tire inverting device of claim 1, wherein the adjustable tire holding device is configured and disposed to hold the first circumferential edge of different sized tires at the first distance from the base.

6. The tire inverting device of claim 5, wherein the tire holding device comprises a plurality of adjustable straps.

7. (canceled)

8. The tire inverting device of claim 1, wherein the pushing mechanism is hydraulically, electrically, or pneumatically activated.

9. A method of inverting a tire comprising the steps of:
disposing a central support with a base;
holding a stand with, and a distance from, the base;
holding a first end of a pushing mechanism with the central support;
supporting a second end of the pushing mechanism with the stand and axially aligning an extendable length of the pushing mechanism, extending between the first end and the second end, and forming a central axis of a tire inverting device;
placing a second circumferential edge or second sidewall of a tire being inverted on the stand and axially aligning a central axis of the tire with the central axis of the tire inverting device;
holding a first circumferential edge of the tire to the stand, with an adjustable holding device, and at a first distance from the base;
adjusting the tire holding device to hold the first circumferential edge of the tire at the first distance from the base;
axially extending the extendable length of the pushing mechanism along the central axis of the tire and the tire inverting device and cooperating the second end of the pushing mechanism with the second circumferential edge of the tire;
pushing the second circumferential edge of the tire, with the pushing mechanism, to a second distance from the base; and
wherein the second distance from the base is greater than the first distance from the base by an amount sufficient to invert the tire, thus inverting the tire.

10. The method of inverting a tire of claim 9, further comprises compromising, separating, or removing at least a portion of a bead disposed proximate the first circumferential edge of the tire, prior to the placing of the second circumferential edge or second sidewall of the tire on the stand.

11. The method of inverting a tire of claim 9, wherein the cooperating the second end of the pushing mechanism comprises cooperating the second end with a tire bead disposed proximate the second edge of the tire.

12. The method of inverting a tire of claim 11, wherein the cooperating the second end of the pushing mechanism comprises cooperating a wheel rim, or portion thereof, disposed with the second end of the pushing mechanism with the tire bead.

13. (canceled)

14. The method of inverting a tire of claim 9, wherein the adjusting the tire holding device to hold the first circumferential edge of the tire at the first distance from the base comprises tightening a plurality of adjustable straps.

15-16. (canceled)

17. The method of inverting a tire of claim 9, further comprising hydraulically, electrically, or pneumatically activating the pushing mechanism and extending its extendable length.

18. The method of inverting a tire of claim 9, further comprising automatically releasing a holding device from the first circumferential edge of the tire upon the inverting of the tire.

19. The method of inverting a tire of claim 10, wherein the compromising, separating, or removing at least a portion of a bead disposed proximate the first circumferential edge of the tire comprises removing a portion of the sidewall.

20. The method of inverting a tire of claim 19, further comprising attaching the removed portion of the sidewall to the second circumferential edge or second sidewall of the tire, upon the inverting of the tire.
